(19) United States
(12) Patent Application Publication
(10) Pub. No.: US 2014/0118315 A1
(43) Pub. Date: May 1, 2014

(54) Interactive Digital Workbook Using Smart Pens

(71) Applicant: Livescribe Inc., Oakland, CA (US)

(72) Inventors: David Robert Black, Sunnyvale, CA (US); Brett Reed Halle, Pleasanton, CA (US); Andrew J. Van Schaack, Nashville, TN (US)

(73) Assignee: Livescribe Inc., Oakland, CA (US)

(21) Appl. No.: 14/062,636

(22) Filed: Oct. 24, 2013

Related U.S. Application Data
(60) Provisional application No. 61/719,292, filed on Oct. 26, 2012.

(51) Int. Cl. G09G 5/00; G06F 3/0354

(52) U.S. Cl. CPC G09G 5/006; G06F 3/03545
USPC 345/179

(57) ABSTRACT

A system and method are disclosed for interacting with digital workbooks. An identifier, identifying a physical workbook, is received. The physical workbook is associated with a digital book and can be displayed on a display screen of a computing system. Captured interactions between the smart pen and the writing surface of the workbook are received. One or more completed areas of the workbook are identified based on the one or more captured interactions. Based on the one or more completed areas of the workbook, a portion of the digital book is selected and displayed.

### CROSS-REFERENCE TO RELATED APPLICATIONS

This application claims the benefit of U.S. Provisional Application No. 61/719,292, entitled “Interactive Digital Workbook Using Smart Pens,” to David Robert Black, Brett Reed Halle, and Andrew J. Van Schaack, filed on Oct. 26, 2012, the contents of which are incorporated by reference herein.

### BACKGROUND

This invention relates generally to pen-based computing systems, and more particularly to synchronizing recorded writing, audio, and digital content in a smart pen environment.

A smart pen is an electronic device that digitally captures writing gestures of a user and converts the captured gestures to digital information that can be utilized in a variety of applications. For example, in an optics-based smart pen, the smart pen includes an optical sensor that detects and records coordinates of the pen while writing with respect to a digitally encoded surface (e.g., a dot pattern). Additionally, some traditional smart pens include an embedded microphone that enable the smart pen to capture audio synchronously with capturing the writing gestures. The synchronized audio and gesture data can then be replayed. Smart pens can therefore provide an enriched note taking experience for users by providing both the convenience of operating in the paper domain and the functionality and flexibility associated with digital environments.

### SUMMARY

Embodiments of the present invention present a new way for interacting with a digital workbook, using a smart pen based computing system.

In one embodiment, the identification of a workbook, associated with a digital book is received. The digital book may, for example, be displayed on a display screen of the computing system. The workbook may be identified by a unique feature, such as a dot pattern or a bar code. Interactions captured by the smart pen are received by the computing system. For example, interactions captured by the smart pen may be gestures written by the user of the smart pen on a writing surface of the workbook. Based on the captured interactions, one or more completed areas of the workbook are identified. A portion of the digital book is selected and displayed based on the one or more completed areas of the workbook. Additional actions may be performed based on captured interactions such as tracking problems answered in the workbook, analyzing equations written in the workbook, grading test solved in the workbook, playing audio and/or video, and the like.

### BRIEF DESCRIPTION OF THE DRAWINGS

FIG. 1 is a schematic diagram of an embodiment of a smart-pen based computing environment.

FIG. 2 is a diagram of an embodiment of a smart pen device for use in a pen-based computing system.

FIG. 3 is a timeline diagram demonstrating an example of synchronized written, audio, and digital content data feeds captured by an embodiment of a smart pen device.

FIG. 4 is a flowchart illustrating an embodiment of a process for interacting with a digital workbook using a smart pen.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview of a Pen-Based Computing Environment

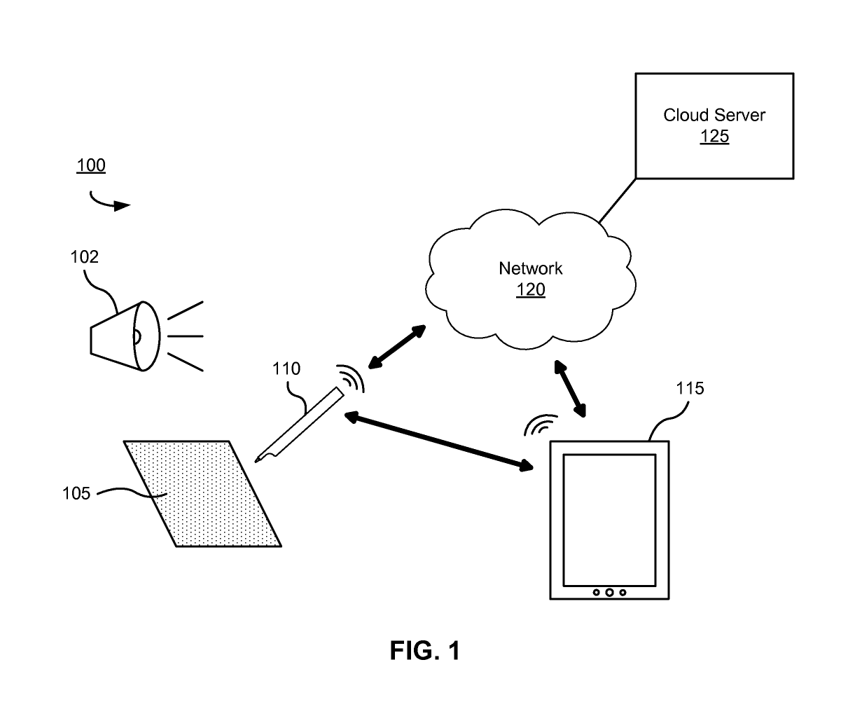

FIG. 1 illustrates an embodiment of a pen-based computing environment 100. The pen-based computing environment comprises an audio source 102, a writing surface 105, a smart pen 110, a computing device 115, a network 120, and a cloud server 125. In alternative embodiments, different or additional devices may be present such as, for example, additional smart pens 110, writing surfaces 105, and computing devices 115 (or one or more device may be absent).

The smart pen 110 is an electronic device that digitally captures interactions with the writing surface 105 (e.g., writing gestures and/or control inputs) and concurrently captures audio from an audio source 102. The smart pen 110 is communicatively coupled to the computing device 115 either directly or via the network 120. The captured writing gestures, control inputs, and/or audio may be transferred from the smart pen 110 to the computing device 115 (e.g., either in real-time or at a later time) for use with one or more applications executing on the computing device 115. Furthermore, digital data and/or control inputs may be communicated from the computing device 115 to the smart pen 110 (either in real-time or an offline process) for use with an application executing on the smart pen 110. The cloud server 125 provides remote storage and/or application services that can be utilized by the smart pen 110 and/or the computing device 115. The computing environment 100 thus enables a wide variety of applications that combine user interactions in both paper and digital domains.

In one embodiment, the smart pen 110 comprises a pen (e.g., an ink-based ball point pen, a stylus device without ink, a stylus device that leaves “digital ink” on a display, a felt marker, a pencil, or other writing apparatus) with embedded computing components and various input/output functionalities. A user may write with the smart pen 110 on the writing surface 105 as the user would with a conventional pen. During the operation, the smart pen 110 digitally captures the writing gestures made on the writing surface 105 and stores electronic representations of the writing gestures. The captured writing gestures have both spatial components and a time component. For example, in one embodiment, the smart pen 110 captures position samples (e.g., coordinate information) of the smart pen 110 with respect to the writing surface 105 at various sample times and stores the captured position information together with the timing information of each sample. The captured writing gestures may furthermore include identifying information associated with the particular writing surface 105 such as, for example, identifying information of a particular page in a particular notebook so as to distinguish between data captured with different writing surfaces 105. In one embodiment, the smart pen 110 also captures other attributes of the writing gestures chosen by the user. For example, ink color may be selected by pressing a physical key on the smart pen 110, tapping a printed icon on the writing surface, selecting an icon on a computer display, etc. This ink information (color, line width, line style, etc.) may also be encoded in the captured data.

The smart pen 110 may additionally capture audio from the audio source 102 (e.g., ambient audio) concurrently with capturing the writing gestures. The smart pen 110 stores the captured audio data in synchronization with the captured writing gestures (i.e., the relative timing between the captured gestures and captured audio is preserved). Furthermore, the smart pen 110 may additionally capture digital content from the computing device 115 concurrently with capturing writing gestures and/or audio. The digital content may include, for example, user interactions with the computing device 115 or synchronization information (e.g., cue points) associated with time-based content (e.g., a video) being viewed on the computing device 115. The smart pen 110 stores the digital content synchronized in time with the captured writing gestures and/or the captured audio data (i.e., the relative timing information between the captured gestures, audio, and the digital content is preserved).

Synchronization may be assured in a variety of different ways. For example, in one embodiment a universal clock is used for synchronization between different devices. In another embodiment, local device-to-device synchronization may be performed between two or more devices. In another embodiment, external content can be combined with the initially captured data and synchronized to the content captured during a particular session.

In an alternative embodiment, the audio and/or digital content 115 may instead be captured by the computing device 115 instead of, or in addition to, being captured by the smart pen 110. Synchronization of the captured writing gestures, audio data, and/or digital data may be performed by the smart pen 110, the computing device 115, a remote server (e.g., the cloud server 125) or by a combination of devices. Furthermore, in an alternative embodiment, capturing of the writing gestures may be performed by the writing surface 105 instead of by the smart pen 110.

In one embodiment, the smart pen 110 is capable of outputting visual and/or audio information. The smart pen 110 may furthermore execute one or more software applications that control various outputs and operations of the smart pen 110 in response to different inputs.

In one embodiment, the smart pen 110 can furthermore detect text or other pre-printed content on the writing surface 105. For example, the smart pen 110 can tap on a particular word or image on the writing surface 105, and the smart pen 110 could then take some action in response to recognizing the content such as playing a sound or performing some other function. For example, the smart pen 110 could translate a word on the page by either displaying the translation on a screen or playing an audio recording of it (e.g., translating a Chinese character to an English word).

In one embodiment, the writing surface 105 comprises a sheet of paper (or any other suitable material that can be written upon) and is encoded with a pattern (e.g., a dot pattern) that can be read by the smart pen 110. The pattern is sufficiently unique to enable to smart pen 110 to determine its relative positioning (e.g., relative or absolute) with respect to the writing surface 105. In another embodiment, the writing surface 105 comprises electronic paper, or e-paper, or may comprise a display screen of an electronic device (e.g., a tablet). In these embodiments, the sensing may be performed entirely by the writing surface 105 or in conjunction with the smart pen 110. Movement of the smart pen 110 may be sensed, for example, via optical sensing of the smart pen device, via motion sensing of the smart pen device, via touch sensing of the writing surface 105, via acoustic sensing, via a fiducial marking, or other suitable means.

The network 120 enables communication between the smart pen 110, the computing device 115, and the cloud server 125. The network 120 enables the smart pen 110 to, for example, transfer captured digital content between the smart pen 110, the computing device 115, and/or the cloud server 125, communicate control signals between the smart pen 110, the computing device 115, and/or cloud server 125, and/or communicate various other data signals between the smart pen 110, the computing device 115, and/or cloud server 125 to enable various applications. The network 120 may include wireless communication protocols such as, for example, Bluetooth, Wifi, cellular networks, infrared communication, acoustic communication, or custom protocols, and/or may include wired communication protocols such as USB or Ethernet. Alternatively, or in addition, the smart pen 110 and computing device 115 may communicate directly via a wired or wireless connection without requiring the network 120.

The computing device 115 may comprise, for example, a tablet computing device, a mobile phone, a laptop or desktop computer, or other electronic device (e.g., another smart pen 110). The computing device 115 may execute one or more applications that can be used in conjunction with the smart pen 110. For example, content captured by the smart pen 110 may be transferred to the computing system 115 for storage, playback, editing, and/or further processing. Additionally, data and or control signals available on the computing device 115 may be transferred to the smart pen 110. Furthermore, applications executing concurrently on the smart pen 110 and the computing device 115 may enable a variety of different real-time interactions between the smart pen 110 and the computing device 115. For example, interactions between the smart pen 110 and the writing surface 105 may be used to provide input to an application executing on the computing device 115 (or vice versa).

In order to enable communication between the smart pen 110 and the computing device 115, the smart pen 110 and the computing device may establish a “pairing” with each other. The pairing allows the devices to recognize each other and to authorize data transfer between the two devices. Once paired, data and/or control signals may be transmitted between the smart pen 110 and the computing device 115 through wired or wireless means.

In one embodiment, both the smart pen 110 and the computing device 115 carry a TCP/IP network stack linked to their respective network adapters. The devices 110, 115 thus support communication using direct (TCP) and broadcast (UDP) sockets with applications executing on each of the smart pen 110 and the computing device 115 able to use these sockets to communicate.

Cloud server 125 comprises a remote computing system coupled to the smart pen 110 and/or the computing device 115 via the network 120. For example, in one embodiment, the cloud server 125 provides remote storage for data captured by the smart pen 110 and/or the computing device 115. Furthermore, data stored on the cloud server 125 can be accessed and used by the smart pen 110 and/or the computing device 115 in the context of various applications.

### Smart Pen System Overview

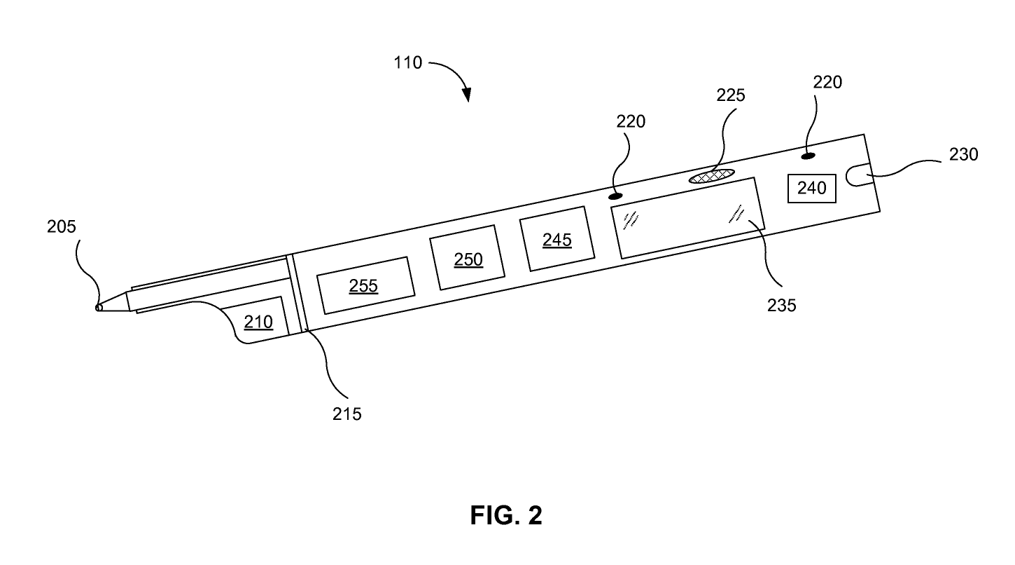

FIG. 2 illustrates an embodiment of the smart pen 110. In the illustrated embodiment, the smart pen 110 comprises a marker 205, an imaging system 210, a pen down sensor 215, one or more microphones 220, a speaker 225, an audio jack 230, a display 235, an I/O port 240, a processor 245, an onboard memory 250, and a battery 255. The smart pen 110 may also include buttons, such as a power button or an audio recording button, and/or status indicator lights. In alternative embodiments, the smart pen 110 may have fewer, additional, or different components than those illustrated in FIG. 2.

The marker 205 comprises any suitable marking mechanism, including any ink-based or graphite-based marking devices or any other devices that can be used for writing. The marker 205 is coupled to a pen down sensor 215, such as a pressure sensitive element. The pen down sensor 215 produces an output when the marker 205 is pressed against a surface, thereby detecting when the smart pen 110 is being used to write on a surface or to interact with controls or buttons (e.g., tapping) on the writing surface 105. In an alternative embodiment, a different type of “marking” sensor may be used to determine when the pen is making marks or interacting with the writing surface 110. For example, a pen up sensor may be used to determine when the smart pen 110 is not interacting with the writing surface 105. Alternative, the smart pen 110 may determine when the pattern on the writing surface 105 is in focus (based on, for example, a fast Fourier transform of a captured image), and accordingly determine when the smart pen is within range of the writing surface 105. In another alternative embodiment, the smart pen 110 can detect vibrations indicating when the pen is writing or interacting with controls on the writing surface 105.

The imaging system 210 comprises sufficient optics and sensors for imaging an area of a surface near the marker 205. The imaging system 210 may be used to capture handwriting and gestures made with the smart pen 110. For example, the imaging system 210 may include an infrared light source that illuminates a writing surface 105 in the general vicinity of the marker 205, where the writing surface 105 includes an encoded pattern. By processing the image of the encoded pattern, the smart pen 110 can determine where the marker 205 is in relation to the writing surface 105. An imaging array of the imaging system 210 then images the surface near the marker 205 and captures a portion of a coded pattern in its field of view.

In other embodiments of the smart pen 110, an appropriate alternative mechanism for capturing writing gestures may be used. For example, in one embodiment, position on the page is determined by using pre-printed marks, such as words or portions of a photo or other image. By correlating the detected marks to a digital version of the document, position of the smart pen 110 can be determined. For example, in one embodiment, the smart pen's position with respect to a printed newspaper can be determined by comparing the images captured by the imaging system 210 of the smart pen 110 with a cloud-based digital version of the newspaper. In this embodiment, the encoded pattern on the writing surface 105 is not necessarily needed because other content on the page can be used as reference points.

In an embodiment, data captured by the imaging system 210 is subsequently processed, allowing one or more content recognition algorithms, such as character recognition, to be applied to the received data. In another embodiment, the imaging system 210 can be used to scan and capture written content that already exists on the writing surface 105. This can be used to, for example, recognize handwriting or printed text, images, or controls on the writing surface 105. The imaging system 210 may further be used in combination with the pen down sensor 215 to determine when the marker 205 is touching the writing surface 105. For example, the smart pen 110 may sense when the user taps the marker 205 on a particular location of the writing surface 105.

The smart pen 110 furthermore comprises one or more microphones 220 for capturing audio. In an embodiment, the one or more microphones 220 are coupled to signal processing software executed by the processor 245, or by a signal processor (not shown), which removes noise created as the marker 205 moves across a writing surface and/or noise created as the smart pen 110 touches down to or lifts away from the writing surface. As explained above, the captured audio data may be stored in a manner that preserves the relative timing between the audio data and captured gestures.

The input/output (I/O) device 240 allows communication between the smart pen 110 and the network 120 and/or the computing device 115. The I/O device 240 may include a wired and/or a wireless communication interface such as, for example, a Bluetooth, Wi-Fi, infrared, or ultrasonic interface.

The speaker 225, audio jack 230, and display 235 are output devices that provide outputs to the user of the smart pen 110 for presentation of data. The audio jack 230 may be coupled to earphones so that a user may listen to the audio output without disturbing those around the user, unlike with a speaker 225. In one embodiment, the audio jack 230 can also serve as a microphone jack in the case of a binaural headset in which each earpiece includes both a speaker and microphone. The use of a binaural headset enables capture of more realistic audio because the microphones are positioned near the user's ears, thus capturing audio as the user would hear it in a room.

The display 235 may comprise any suitable display system for providing visual feedback, such as an organic light emitting diode (OLED) display, allowing the smart pen 110 to provide a visual output. In use, the smart pen 110 may use any of these output components to communicate audio or visual feedback, allowing data to be provided using multiple output modalities. For example, the speaker 225 and audio jack 230 may communicate audio feedback (e.g., prompts, commands, and system status) according to an application running on the smart pen 110, and the display 235 may display word phrases, static or dynamic images, or prompts as directed by such an application. In addition, the speaker 225 and audio jack 230 may also be used to play back audio data that has been recorded using the microphones 220. The smart pen 110 may also provide haptic feedback to the user. Haptic feedback could include, for example, a simple vibration notification, or more sophisticated motions of the smart pen 110 that provide the feeling of interacting with a virtual button or other printed/displayed controls. For example, tapping on a printed button could produce a “click” sound and the feeling that a button was pressed.

A processor 245, onboard memory 250 (e.g., a non-transitory computer-readable storage medium), and battery 255 (or any other suitable power source) enable computing functionalities to be performed at least in part on the smart pen 110. The processor 245 is coupled to the input and output devices and other components described above, thereby enabling applications running on the smart pen 110 to use those components. As a result, executable applications can be stored to a non-transitory computer-readable storage medium of the onboard memory 250 and executed by the processor 245 to carry out the various functions attributed to the smart pen 110 that are described herein. The memory 250 may furthermore store the recorded audio, handwriting, and digital content, either indefinitely or until offloaded from the smart pen 110 to a computing system 115 or cloud server 125.

In an embodiment, the processor 245 and onboard memory 250 include one or more executable applications supporting and enabling a menu structure and navigation through a file system or application menu, allowing launch of an application or of a functionality of an application. For example, navigation between menu items comprises an interaction between the user and the smart pen 110 involving spoken and/or written commands and/or gestures by the user and audio and/or visual feedback from the smart pen computing system. In an embodiment, pen commands can be activated using a “launch line.” For example, on dot paper, the user draws a horizontal line from right to left and then back over the first segment, at which time the pen prompts the user for a command. The user then prints (e.g., using block characters) above the line the desired command or menu to be accessed (e.g., Wi-Fi Settings, Playback Recording, etc.). Using integrated character recognition (ICR), the pen can convert the written gestures into text for command or data input. In alternative embodiments, a different type of gesture can be recognized to enable the launch line. Hence, the smart pen 110 may receive input to navigate the menu structure from a variety of modalities.

### Synchronization of Written, Audio and Digital Data Streams

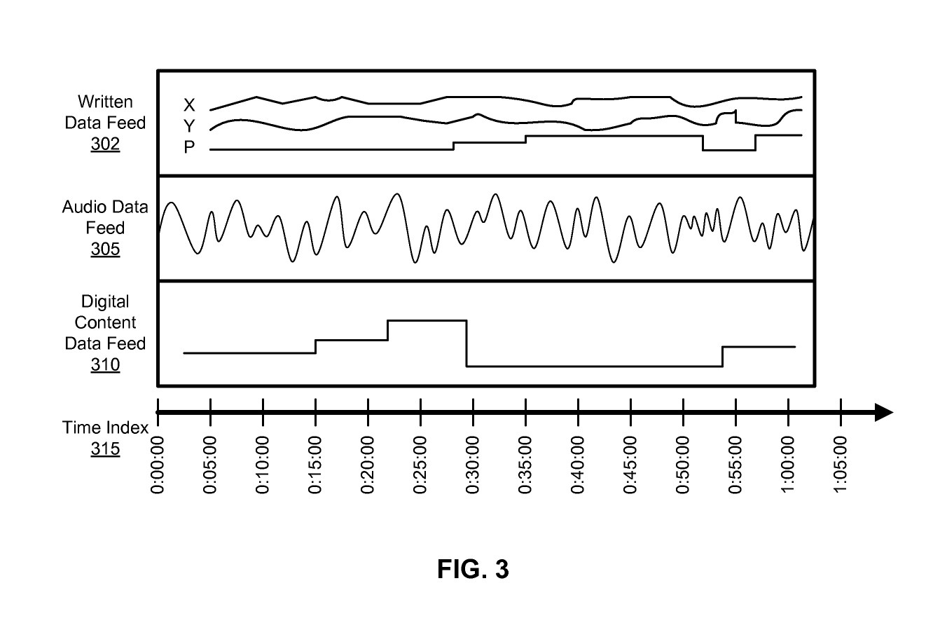

FIG. 3 illustrates an example of various data feeds that are present (and optionally captured) during operation of the smart pen 110 in the smart pen environment 100. For example, in one embodiment, a written data feed 300, an audio data feed 305, and a digital content data feed 315 are all synchronized to a common time index 315. The written data feed 302 represents, for example, a sequence of digital samples encoding coordinate information (e.g., “X” and “Y” coordinates) of the smart pen's position with respect to a particular writing surface 105. Additionally, in one embodiment, the coordinate information can include pen angle, pen rotation, pen velocity, pen acceleration, or other positional, angular, or motion characteristics of the smart pen 110. The writing surface 105 may change over time (e.g., when the user changes pages of a notebook or switches notebooks) and therefore identifying information for the writing surface is also captured (e.g., as page component “P”). The written data feed 302 may also include other information captured by the smart pen 110 that identifies whether or not the user is writing (e.g., pen up/pen down sensor information) or identifies other types of interactions with the smart pen 110.

The audio data feed 305 represents, for example, a sequence of digital audio samples captured at particular sample times. In some embodiments, the audio data feed 305 may include multiple audio signals (e.g., stereo audio data). The digital content data feed 310 represents, for example, a sequence of states associated with one or more applications executing on the computing device 115. For example, the digital content data feed 310 may comprise a sequence of digital samples that each represents the state of the computing device 115 at particular sample times. The state information could represent, for example, a particular portion of a digital document being displayed by the computing device 115 at a given time, a current playback frame of a video being played by the computing device 115, a set of inputs being stored by the computing device 115 at a given time, etc. The state of the computing device 115 may change over time based on user interactions with the computing device 115 and/or in response to commands or inputs from the written data feed 302 (e.g., gesture commands) or audio data feed 305 (e.g., voice commands). For example, the written data feed 302 may cause real-time updates to the state of the computing device 115 such as, for example, displaying the written data feed 302 in real-time as it is captured or changing a display of the computing device 115 based on an input represented by the captured gestures of the written data feed 302. While FIG. 3 provides one representative example, other embodiments may include fewer or additional data feeds (including data feeds of different types) than those illustrated.

As previously described, one or more of the data feeds 302, 305, 310 may be captured by the smart pen 110, the computing device 115, the cloud server 120 or a combination of devices in correlation with the time index 315. One or more of the data feeds 302, 305, 310 can then be replayed in synchronization. For example, the written data feed 302 may be replayed, for example, as a “movie” of the captured writing gestures on a display of the computing device 115 together with the audio data feed 305. Furthermore, the digital content data feed 310 may be replayed as a “movie” that transitions the computing device 115 between the sequence of previously recorded states according to the captured timing.

In another embodiment, the user can then interact with the recorded data in a variety of different ways. For example, in one embodiment, the user can interact with (e.g., tap) a particular location on the writing surface 105 corresponding to previously captured writing. The time location corresponding to when the writing at that particular location occurred can then be determined. Alternatively, a time location can be identified by using a slider navigation tool on the computing device 115 or by placing the computing device 115 is a state that is unique to a particular time location in the digital content data feed 210. The audio data feed 305, the digital content data feed 310, and or the written data feed may be re-played beginning at the identified time location. Additionally, the user may add to modify one or more of the data feeds 302, 305, 310 at an identified time location.

Interaction with a Digital Workbook

In one embodiment, the smart pen computing system described above can be used together with a “workbook” to enable a variety of smart pen applications. The workbook comprises a writing surface 105 that has pre-existing printed content overlaid with an encoded pattern recognizable by the smart pen 110. The workbook may be associated with a digital book viewable on the computing device 115 and generally provides supplementary interactive material to aid the learning of a subject.

The production and distribution of workbooks in conjunction with digital textbooks may enable an important monetization model for textbook publishers. Traditional paper-based textbooks are usually expensive and their price can range anywhere from a few tens of dollars to several thousand dollars. For this reason, students normally try to find affordable alternatives to buying a brand new textbook. A large number of students buy used or second hand textbooks instead of buying a brand new copy of a textbook. Other students buy or download digital versions of the textbooks. Yet other students simply borrow the textbook from a library. In all those cases, the publishers lose money by not being able to sell a new copy of its textbook.

A workbook that complements the textbook (digital or otherwise) provides an alternative source of revenue for publishers. For example, a publisher may provide a workbook with assignments and exercises for solving directly in the workbook. Since the workbook is being consumed in the course of a class (or as the student solves the problems in it), each student is more likely to purchase a brand new copy of the workbook. In order to make workbooks more attractive to students and teachers, interactive elements and extended content can be tied to the possession of those workbooks. A watermark of a dot pattern can be overlaid on the pages of a workbook and a smart pen 110 connected (directly or indirectly) to a computing device 115 can be use to interact with the workbook. Using the smart pen system in conjunction with the workbook enables activities such as, for example, digital tracking of problems answered in the workbook, analysis of equations solving, administration and grading of quizzes or tests, playback of linked audio through the smart pen 110 or the computing device 115, playback of video on the computing device 115, etc.

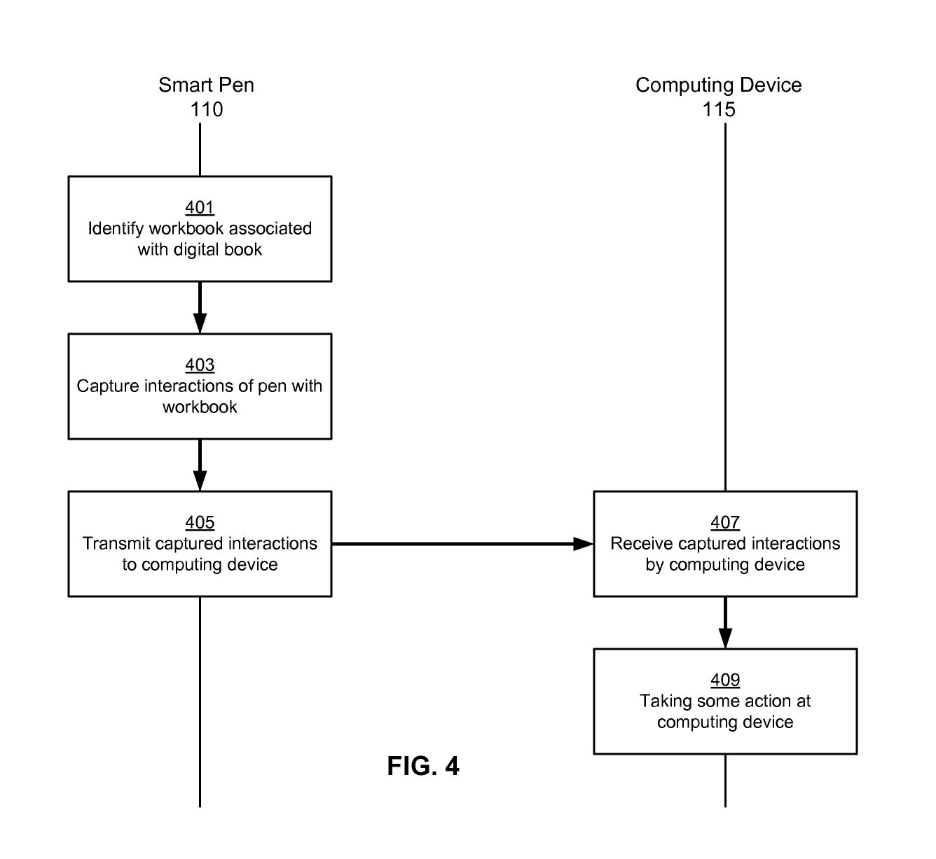

FIG. 4 is a flowchart illustrating an embodiment of a process for interacting with a digital workbook using a smart pen 110. To enable the interaction with the digital workbook, the smart pen 110 first identifies 401 the workbook associated with a digital book, which may be concurrently viewed on the computing device 115. In one embodiment, each workbook contains a unique feature (e.g., dot pattern, barcode, etc.) that the smart pen 110 can recognize and use to differentiate the current workbook from other workbooks. In another embodiment, the user identifies the workbook and tells the smart pen 110 (e.g., either via an input method directly available in the smart pen 110, or via the computing device 115 connected to the smart pen 110) which workbook is currently being used. After the smart pen 110 identifies the workbook, the smart pen 110 may optionally identify the digital book associated with the workbook. In another embodiment, the smart pen 110 does not necessarily identify the digital book.

After the smart pen 110 has identified the workbook, it can start capturing 403 the interactions (e.g., writing gestures or control inputs) of the smart pen 110 with the workbook. The smart pen 110 then transmits 405 the captured interactions to the computing device 115. In some embodiments, either the smart pen 110, the computing device 115, or both can also save the captured interactions in a non-transitory computer readable storage medium. The transmission of the captured interactions can be substantially in real time (i.e., as the user is writing in the workbook) or at a later time (e.g., after the user is done working with a particular section of the workbook).

Finally, after the captured interactions are received 407 by the computing device 115, an action is triggered 409 in the computing device 115 that supplements, enhances, or responds to the interaction of the user with the workbook.

Many different types of actions can be triggered in the computing device 115 in response to different types of interactions of the smart pen 110 with the workbook. In an exemplary embodiment, a digital textbook may contain “hidden” or “bonus” content that can only be seen after a predetermined interaction with the workbook has been performed. For example, the workbook can contain special regions that can act as buttons which, when selected, can enable the hidden or bonus content. In another embodiment, the bonus content can be enabled after correctly completing an assignment or set of assignments. Hidden or bonus content can include, for example, a video played on the computing device 115 that supplements the material being learned, a further reading section available on the computing device 115 that reinforces the material being learned, etc.

In another exemplary embodiment, the workbook can contain quizzes and tests. The user completes the quiz or test in the digital workbook using the smart pen 110 and the answers are transferred to the computing device 115. The computing device 115 can then analyze the solutions written in the pages of the workbook to determine if the student's work is correct. The quizzes and tests can be automatically graded by an application on the computing device 115 and the equations and diagrams can be parsed and evaluated for correctness. The computing device 115 can also use an application associated with the digital textbook, or access a private website or web server to keep track of the student's progress. Furthermore, the computing device 115 can give a comparison of the student's work to work by other students (e.g., compared to other students in the same class, a nationwide ranking, or the like). These services may be implemented by an application on the computing device 115 or on the cloud server 125.

Another exemplary embodiment allows students to take notes in the workbook and transfer the notes to the digital textbook. For example, the notes can be taken at special regions within the workbook. The notes can also include audio information synchronized with the writing. The notes (and optionally synchronized audio) can be attached to and saved in association with a particular page of the textbook. This allows a more effective exam preparation by students.

In yet another exemplary embodiment, the computing device 115 keeps track of the areas of the workbook that have been interacted with by the student. Then, an application associated with the digital textbook (or a separate application), can adjust the suggested order and depth of the content presented in the digital textbook. Areas or topics not extensively explored by the student, or areas in which the student has shown difficulty in completing the exercises or assignments, can be prioritized for review and additional study. In another embodiment, customized workbook pages can be generated by the computing device 115 based on the quality of the students responses on previous assignments. These pages can be printed using conventional inkjet or laser printers.

In one embodiment, when multiple choice questions, or simple handwriting recognition (HWR) is not sufficient, the computing device 115 can analyze the gestures entered by the user to better determine if the user has successfully completed an exercise. For example, if the user is entering an equation or formula, HWR may recognize the characters within the equation, but may not be able to correctly parse the equation. By using a special application associated with digital book (or companion software executing on the computing device 115 or cloud server 125), the gestures entered by the user can be analyzed, interpreted and encoded into the proper form to be further processed. For example, if the computing device 115 determines that the gestures entered by the user constitutes an equation, the computing device 115 can interpret the equation, properly encode it, and send it to an equation solver to be evaluated. In another exemplary use, if the user draws a diagram using a smart pen 110, an application on the computing device 115 (or cloud server 125) can recognize the different components to determine whether the proper elements are present.

In one exemplary embodiment, when the workbook pages have been completed, they can be transmitted to a teacher or instructor for their review as a standalone PDF file or some other format. Teachers or instructors can then provide handwritten or spoken feedback to the student. In one embodiment, the feedback or comments are added to the digital copy that was sent to the teacher. In another embodiment, the feedback or comments are added to a printed version of the document sent to the teacher. After the teacher has added feedback and comments, the digital copy or printed copy of the workbook that includes the feedback and comments can be transferred back to the student.

In another exemplary embodiment, students can access a variety of reference materials by simply tapping on words or images in the workbook. Tapping on a word could bring up its definition, its pronunciation (audio recording), translation to second language, etc.

In another exemplary embodiment, users can record spoken answers using the microphone 220. Recorded responses are stored in the smart pen 110 and can be transferred to the computing device 115 or to the cloud 125 to be later accessed (e.g., by a teacher). This would be particularly beneficial in foreign language classes. While conventional courses are generally limited to assignments involving reading and writing, use of the workbook and smart pen 110 enable listening and speaking to become part of the assignments, which are generally desirable to practice for language proficiency.

In another exemplary embodiment, if the workbook is ever lost, a digital version of it together with the student's entire work up to date is stored digitally in the computing device 115 or in the cloud 125.

In another exemplary embodiment, pages that a student navigates to on the computing device 115, can be linked by writing an identifying tag on a workbook page. For example, the teacher asks the student to find three animal videos. The student navigates to a skunk video using the computing device 115 and writes the word “Skunk” in the workbook. If the student taps on the word “Skunk” in the future, the computing device 115 jumps to the skunk video. Also, if the student sends homework to the teacher as a PDF file, when the teacher clicks on the link, a new window pops up showing the skunk video. In one embodiment, links to web-based content may appear in a different color on the digital representation of the workbook page.

In another exemplary embodiment, tapping on words or images in a workbook page may trigger corresponding pages of the digital textbook to be displayed on the computing device 115. For example, glossaries or worked solutions can be displayed to the user to aid the student solving a problem in the workbook. Also, tapping on icons printed onto the pages of the workbook can play audio (music, foreign language conversations, second language instructions, etc.), or trigger videos to be presented by a computing device 115. The benefit to the student is that the student can rapidly navigate to web-based multimedia content without worrying about getting lost or distracted by non-academic content.

### ADDITIONAL EMBODIMENTS

The foregoing description of the embodiments has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program instructions, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for interacting with digital workbooks, the method comprising:
receiving, from a smart pen device, an identifier identifying a physical workbook;
identifying a digital book, stored on a non-transitory computer readable medium, associated with the identifier of the physical workbook;
receiving one or more captured interactions between the smart pen device and a writing surface of the workbook;
identifying one or more completed areas of the workbook based on the one or more captured interactions;
selecting, by a computing system, a portion of the digital book to display based on the one or more completed areas of the workbook; and
displaying the selected portion of the digital book on a display of the computing system.

2. The method of claim 1, further comprising:
identifying one or more areas of the workbook that are not successfully completed based on the one or more captured interactions; and
adjusting displayed content of the digital book associated with the digital workbook based on the identified areas.

3. The method of claim 2, further comprising:
generating customized workbook pages based on the identified area of the workbook not successfully completed.

4. The method of claim 1, further comprising:
analyzing the captured interactions between the smart pen device and the writing surface of the workbook to identify a plurality of characters written by the smart pen device;
interpreting the plurality of characters to determine whether the plurality of characters constitute an equation written in the workbook;
encoding the equation; and
evaluating the encoded equation using an equation solver.

5. The method of claim 1, further comprising:
analyzing the captured interactions to determine a plurality of solutions written by the smart pen device;
parsing each of the plurality of solutions; and
evaluating the parsed solutions to determine whether each of the plurality of solutions are correct.

6. The method of claim 1, further comprising:
playing a linked media item.

7. The method of claim 1, further comprising:
determining that a task of the workbook has been completed; and
responsive to the task being completed, enabling access to previously inaccessible content of the digital book associated with completion of the task.

8. The method of claim 1, further comprising:
storing the interactions between the smart pen device and the workbook in association with a corresponding portion of the digital book.

9. The method of claim 1, further comprising:
determining a location of the captured interaction in the workbook;
determining a word associated with the determined location; and
performing one of displaying a definition of the word, playing a recorded pronunciation of the word, and translating the word.

10. The method of claim 1, further comprising:
obtaining a recording of a spoken answer to a question of the workbook; and
storing the spoken answer to a storage medium in association with the question.

11. The method of claim 1, wherein the interactions are received in substantially real-time.

12. The method of claim 1, wherein identifying the workbook comprises:
recognizing a unique feature of the workbook, wherein the unique feature is selected from a list consisting of a dot pattern, and a barcode.

13. A system comprising:
a smart pen device; and
a non-transitory computer readable medium configured to store instructions, the instructions when executed by a processor of a computing system, cause the processor to:
receive an identifier identifying a physical workbook;
identify a digital book associated with the identifier of the physical workbook;
receive one or more captured interactions between the smart pen device and a writing surface of the workbook;
identifying one or more completed areas of the workbook based on the one or more captured interactions;
select a portion of the digital book to display based on the one or more completed areas of the workbook; and
display the selected portion of the digital book on a display of the computing system.

14. The system of claim 13, wherein the instructions further cause the processor to:
identify one or more areas of the workbook that are not successfully completed based on the one or more captured interactions; and
adjust displayed content of the digital book associated with the digital workbook based on the identified areas.

15. The system of claim 13, wherein the instructions further cause the processor to:
analyze the captured interactions between the smart pen device and the writing surface of the workbook to identify a plurality of characters written by the smart pen device;
interpret the plurality of characters to determine whether the plurality of characters constitute an equation written in the workbook;
encode the equation; and
evaluate the encoded equation using an equation solver.

16. The system of claim 13, 4 wherein the instructions further cause the processor to:
analyze the captured interactions to determine a plurality of solutions written by the smart pen device;
parse each of the plurality of solutions; and
evaluate the parsed solutions to determine whether each of the plurality of solutions are correct.

17. A non-transitory computer readable medium configured to store instructions for interacting with digital workbooks, the instructions when executed by a processor cause the processor to:
receive an identifier identifying a physical workbook;
identify a digital book associated with the identifier of the physical workbook;
receive one or more captured interactions between the smart pen device and a writing surface of the workbook;
identifying one or more completed areas of the workbook based on the one or more captured interactions;
select a portion of the digital book to display based on the one or more completed areas of the workbook; and
display the selected portion of the digital book on a display of the computing system.

18. The computer readable medium of claim 17, wherein the instructions further cause the processor to:
identify one or more areas of the workbook that are not successfully completed based on the one or more captured interactions; and
adjust displayed content of the digital book associated with the digital workbook based on the identified areas.

19. The computer readable medium of claim 17, wherein the instructions further cause the processor to:
analyze the captured interactions between the smart pen device and the writing surface of the workbook to identify a plurality of characters written by the smart pen device;
interpret the plurality of characters to determine whether the plurality of characters constitute an equation written in the workbook;
encode the equation; and
evaluate the encoded equation using an equation solver.

20. The computer readable medium of claim 17, wherein the instructions further cause the processor to:
analyze the captured interactions to determine a plurality of solutions written by the smart pen device;
parse each of the plurality of solutions; and
evaluate the parsed solutions to determine whether each of the plurality of solutions are correct.
